(19) United States
(12) Patent Application Publication
(10) Pub. No.: US 2003/0223455 A1
(43) Pub. Date: Dec. 4, 2003

(54) Method and system for communication using a portable device

(75) Inventor: Osama Rashdan, Kettering, OH (US)

Correspondence Address: BAKER BOTTS L.L.P., 2001 ROSS AVENUE, SUITE 600, DALLAS, TX, 75201-2980, US

(73) Assignee: Electronic Data Systems Corporation

(21) Appl. No.: 10/158,332

(22) Filed: May 29, 2002

(51) Int. Cl. H04J 3/16; H04Q 7/00

(52) U.S. Cl. 370/466; 370/328

(57) ABSTRACT

A method for communicating using a portable device includes providing to a first person a plurality of messages for communication to another person. The plurality of messages are provided in a first format at a portable device. The method includes receiving from the first person a first selection at the portable device. The first selection comprises a first message that the first person desires to communicate to the second person. The first message is selected from the plurality of messages. The method includes translating the first message from the first format to a second format and communicating the first message to the second person in the second format using the portable device. The first format may comprise sign language or a picture format, and the second format may comprise an audible or text format.

### TECHNICAL FIELD OF THE INVENTION

This invention relates generally to the field of communications and, more particularly, to a method and system for communication using a portable device.

### BACKGROUND OF THE INVENTION

Many individuals who are autistic, particularly many autistic children, are not capable of learning or communicating in similar ways to nonautistic individuals. The autistic individuals may have trouble verbally communicating with others in an effective manner. Autistic individuals may need to use sign language in order to communicate with others. However, this communication may be hindered, for example, if the autistic individual has trouble signing properly or if the person with whom the autistic individual desires to communicate does not know sign language. Other individuals, such as deaf individuals, may also have difficulty verbally communicating effectively, through sign language or otherwise.

### SUMMARY OF THE INVENTION

The present invention provides a method and system for communicating using a portable device that substantially eliminates or reduces at least some of the disadvantages and problems associated with previous communication methods and systems.

In accordance with a particular embodiment of the present invention, a method for communicating using a portable device includes providing to a first person a plurality of messages for communication to another person. The plurality of messages is provided in a first format at a portable device. The method includes receiving from the first person a first selection at the portable device. The first selection comprises a first message that the first person desires to communicate to the second person. The first message is selected from the plurality of messages. The method includes translating the first message from the first format to a second format and communicating the first message to the second person in the second format using the portable device. The first format may comprise sign language or a picture format, and the second format may comprise an audible or text format.

In accordance with another embodiment, a system for communication includes a portable device. The portable device includes a database comprising a plurality of messages for communication. The portable device also includes a processor coupled to the database and a personal communications assistant operable for execution by the processor. The personal communications assistant is operable to provide the plurality of messages to a first person in a first format through an output device coupled to the processor. The personal communications assistant is also operable to receive from the first person a first selection comprising a first message that the first person desires to communicate to a second person. The first selection is received through an input device coupled to the processor. The first message is selected from the plurality of messages. The personal communications assistant is also operable to translate the first message from the first format to a second format and communicate the first message to the second person in the second format through the output device. The first format may comprise sign language or a picture format, and the second format may comprise an audible or text format.

Technical advantages of particular embodiments of the present invention include a method and system for communication using a portable device that enables a person who has difficulty verbally communicating effectively with others (a “non-verbal person”) to communicate with others. The non-verbal person may select a message at the portable device in a format that the non-verbal person understands, and the portable device communicates the message to second person in a format that the second person understands. Thus, non-verbal persons are able to communicate more effectively. The system and method may also encourage more communication between non-verbal persons and other people.

Another technical advantage of particular embodiments of the present invention includes a portable device that includes a personal communications assistant that facilitates communication between non-verbal persons and others. The personal communications assistant is compatible with conventional operating systems and multiple platforms. The flexibility of the personal communications assistant may reduce a need for customized communications devices, saving expense and resources.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 illustrates a system for communication using a portable device, in accordance with an embodiment of the present invention;

FIG. 2 illustrates a system for loading and storing messages for communication onto a portable device, in accordance with an embodiment of the present invention;

FIG. 3 illustrates a portable device, in accordance with an embodiment of the present invention; and

FIG. 4 illustrates a flow chart for communicating using a portable device, in accordance with another embodiment of the present invention.

### DETAILED DESCRIPTION OF THE INVENTION

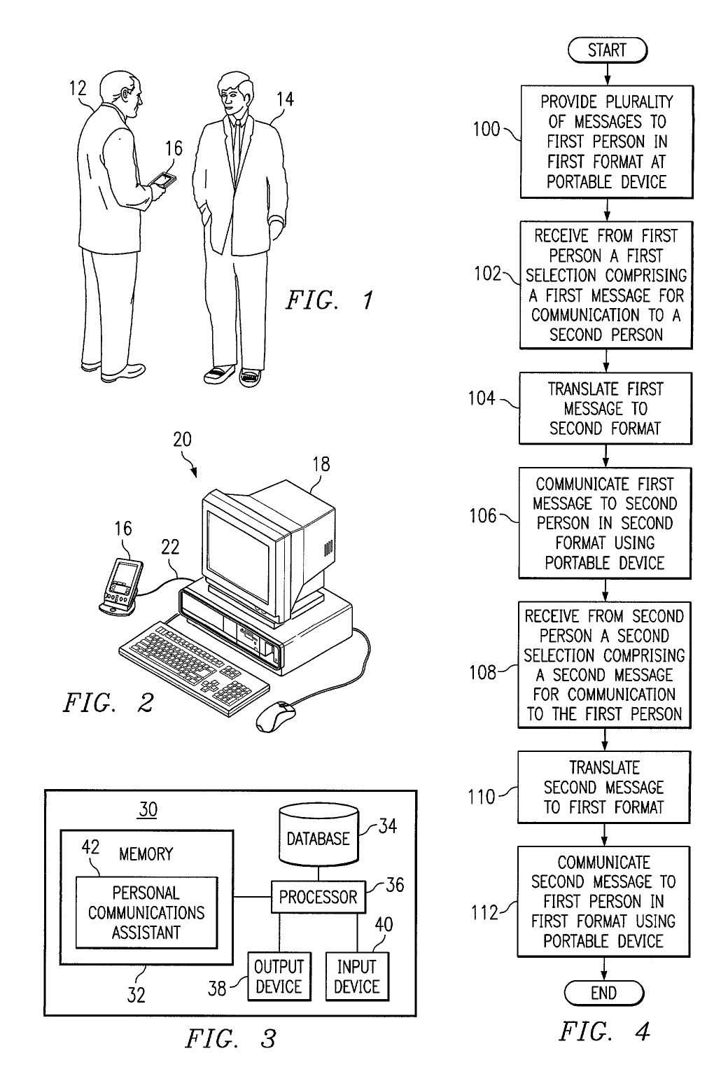

FIG. 1 illustrates a system and method for communication using a portable device in accordance with an embodiment of the present invention. In FIG. 1, a first person 12 communicates with a second person 14 using a portable device 16. In the illustrated embodiment, first person 12 is an autistic person who has difficulty verbally communicating with other people. In other embodiments, first person 12 may be a deaf or other type of person who cannot effectively verbally communicate with others (a “non-verbal person”). In some embodiments, a non-verbal person may be someone who does not speak the same language as one with whom the non-verbal person desires to communicate. In some cases, first person 12 may have more difficulty effectively conveying a verbal message to another person than receiving a verbal message from another person. First person 12 selects a message at the portable device that first person 12 desires to communicate to second person 14. Portable device 16 then communicates the message to the second person by audibly speaking the message. Thus, FIG. 1 illustrates a manner for communication in which a person who has difficulty verbally communicating with others can effectively communicate a message to another person.

In the illustrated embodiment, portable device 16 is a small, mobile, hand-held device such as a personal digital assistant (PDA); however, other embodiments may utilize other types of portable devices such as a mobile telephone. Portable device 16 may be reinforced with protective plastic, rubber, or other materials or components to reduce the risk of damage to the device. Portable device 16 may also include a component to aid in the carrying of the device by first person 12, such as an arm strap or a belt clip.

When first person 12 desires to communicate with second person 14, portable device 16 provides to first person 12 a plurality of messages which may be communicated to another person. In particular embodiments, portable device 16 may provide such messages through a menu or catalogue of messages. The messages provided by portable device 16 include messages which first person 12 may desire to communicate to others. The messages may be of various types, such as messages to communicate desires and/or needs of first person 12. Examples of such messages may include “I need to go to the bathroom” or “I want a pretzel.” Any type of message that first person 12 may desire to communicate to another person may be provided at portable device 16.

The messages provided at portable device 16 may be displayed to first person 12 in a format that first person 12 understands. Such format may include sign language, pictures, symbols or other formats. As stated above, in this embodiment first person 12 is an autistic person who has difficulty effectively verbally communicating with others. Such difficulty may result for any of a number of reasons. For example, first person 12 may understand sign language but may have difficulty communicating with those who do not understand sign language. As another example, first person 12 may understand sign language buy may have difficulty signing properly. First person 12 may also be able to communicate through a picture exchange communication system (PECS) by indicating pictures which represent messages that first person 12 desires to communicate to another person.

For example, if first person 12 is able to understand and communicate using sign language, portable device 16 displays a plurality of messages to first person 12 in sign language. The message may be displayed by displaying a hand making the appropriate sign(s) that convey such a message. Portable device 16 may display a plurality of messages using appropriate pictures if first person 12 is able to understand and communicate through PECS. By displaying the plurality of messages to first person 12 in a format that first person 12 understands, such as sign language, pictures, symbols or other appropriate means, first person 12 will be able to comprehend each message so that first person 12 can select the message that first person 12 desires to communicate to second person 14.

First person 12 selects a message from the plurality of messages provided by portable device 16. The message that first person 12 selects is a message that first person 12 desires to communicate to second person 14. First person 12 may select the message in any of a variety of ways, such as by directing a cursor or prompt on portable device 16 or by touching an appropriate part of a display screen of portable device 16 to indicate the message that first person 12 desires to select. Other means may also be used by first person 12 to select the message, such as a keyboard, keypad, mouse, trackwheel or touch pad.

In particular embodiments, first person 12 may advance through multiple menus and/or prompts provided by portable device 16 in order to select the message first person 12 desires to communicate to second person 14. The plurality of messages may be displayed through different menus or categories. For example, portable device 16 may display one menu of certain “high-level” commands that first person 12 may choose from, such as “I want,” “I need” and “Would you like to.” First person 12 may select a high-level command that corresponds with the message that first person 12 desires to communicate. Then, portable device 16 may display another menu of certain items or tasks to follow the high-level command selected by first person 12. First person 12 may then select an item or task from this menu. The selections of the high-level command and the item or task form a completed message that first person 12 desires to communicate to second person 14.

For example, if first person 12 selected the high-level command “I want,” then portable device 16 could display any of a number of images (through sign language, pictures, symbols or other means) which may follow the phrase “I want” to form a completed message, such as a pretzel, a piece of chicken or a glass of water. First person 12 may select the item to follow “I want” to form the message that first person 12 desires to communicate to second person 14. As another example, first person 12 may select the high-level command “I need” and may then select an image of a bathroom to indicate that first person 12 would like to communicate a message that first person 12 needs to go to the bathroom. An infinite number of messages can be selected by first person 12 in this manner.

Once first person 12 has selected a message for communication, the message is translated from the format in which the message was provided to and selected by first person 12, such as sign language, pictures or symbols, to a format in which the message may be communicated to and understood by second person 14, such as a text or audible format.

After translation, portable device 16 communicates the message to second person 14 in the format to which the message has been translated. Such communication may occur in a variety of ways. If the message has been translated to an audible format, portable device 16 may communicate the message by audibly outputting a voice communicating the message. For example, if the message first person 12 has selected to communicate to second person 14 is “I want a pretzel,” then portable device 16 may audibly output a voice saying “I want a pretzel.” The voice may be a computerized voice or a human voice. For example, the voice may be one that is familiar to first person 12 such as the voice of a parent of first person 12. Communicating the message to second person 14 using a voice familiar to first person 12, such as the voice of a parent of first person 12, provides familiarity, comfort and safety to first person 12. Since first person 12 is autistic, first person 12 may lack social components and may therefore be introverted and may tend to shy away from communicating with others. Hearing a familiar voice such as the voice of a parent may encourage first person 12 to communicate more. In particular embodiments portable device 16 may communicate the message that first person 12 desires to communicate to second person 14 in languages other than English. Such languages may be selected using an input device of portable device 16, such as a keypad. The ability to communicate a message in various languages can enable first person 12 to communicate more effectively with non-English speaking persons.

If the message has been translated to a text format, portable device 16 may communicate the message selected by first person 12 to second person 14 by displaying a text version of the message. In such a case, second person 14 may view portable device 16 to receive the message. Other ways of communicating the message to second person 14 may be utilized, depending on the format to which the message has been translated. For example, if the message has been translated to a picture format, then portable device 16 may communicate the message to second person 14 by displaying one or more pictures representing the message for second person 14. Since second person 14 may not be able to understand messages in formats that first person 12 understands, such as messages in sign language, the illustrated system and method provides a manner in which first person 12 and second person 14 can effectively communicate. The system and method illustrated may also encourage more communication between first person 12 and second person 14. The system and method may be used by families to help bridge the gap between family members and a non-verbal person such as an autistic or deaf child.

In particular embodiments, second person 14 may communicate a response message to first person 12. The response message may be selected by second person 14 from the plurality of messages. Second person 14 may select the response message at the portable device through a keyboard, keypad, mouse, trackwheel, touch pad or other input device. Portable device 16 translates the response message from a format in which second person 14 selected the message to a format that first person 12 understands. The response message may then be communicated to first person 12 in the format to which it was translated. For example, portable device 16 may display the response message for first person 12 in sign language, pictures or symbols. In particular embodiments, portable device 16 may include voice recognition technology such that portable device is able to receive a message second person 14 desires to communicate to first person 12 in an audible format, spoken by second person 14, and translate the message to a format that first person 12 understands for communication to first person 12.

FIG. 2 illustrates a system 20 for loading and storing messages onto a portable device for communication between a non-verbal person and another person. Portable device 16 is coupled to stationary device 18 through communication link 22. Communication link 22 may be a wireline, fiber optic, wireless or other type of link that enables data to be communicated between portable device 16 and stationary device 18. Stationary device 18 may be a desktop computer, laptop computer or other type of personal computer or device operable to receive, store and process data and communicate data to portable device 16.

Stationary device 18 may be used to train a non-verbal person, such as first person 12 of FIG. 1, to communicate through methods and systems of the present invention. Such training may be accomplished by teaching first person 12 to associate particular signs, pictures or symbols with messages that such signs, pictures or symbols may convey.

Particular signs, symbols, pictures and other types of formats which represent messages for first person 12 and the formats to which such representations may be translated for communication as messages to second person 14 of FIG. 1 may be received and stored at stationary device 18. The messages in their various formats may be received from a user inputting the messages into stationary device 18 or from a disk, CD-ROM or other storage device. For example, as discussed above, a person, such as a parent of first person 12, may record their voice into stationary device 18 in a manner such that messages selected by first person 12 for communication to another person may be translated to and communicated in the recorded human voice. The messages may also be downloaded from an intranet, internet or other network.

The messages stored at stationary device 18 may be transmitted to and stored on portable device 16 through communication link 22. A non-verbal person may then communicate with another person using portable device 16 and the messages stored thereon as described above with respect to FIG. 1. In particular embodiments, messages may be directly stored on portable device 16 from another source such as a disk, CD-ROM, network or other source without using stationary device 16.

FIG. 3 illustrates a portable device 30 in accordance with an embodiment of the present invention. Portable device 30 includes a memory 32, a database 34, a processor 36, an output device 38 and an input device 40. Processor 36 is typically a microprocessor, controller or any other suitable computing device or resource. Output device 38 may be a display screen, a speaker or other component through which a message may be provided or communicated to a person. In particular embodiments, output device 38 may comprise more than one component, such as a display screen and a speaker. Input device 40 may be a keyboard, keypad, mouse, trackwheel, touch pad or other component which may be utilized for message selection or menu navigation.

Memory 32 will usually be any form of volatile or non-volatile memory including, without limitation, magnetic media, optical media, random access memory (RAM), read-only memory (ROM), removable media or any other suitable memory component. Memory 32 includes components or software executable by processor 36. Components of memory 32 may be otherwise combined and/or divided for processing within the scope of the present invention. Memory 32 includes a personal communications assistant (PCA) 42.

PCA 42 manages the communications process between persons communicating through portable device 30. PCA 42 provides messages to a non-verbal person desiring to communicate with another person using output device 38 of portable device 30. The messages are provided in a format that the non-verbal person can understand, such as sign language, pictures or symbols. PCA 42 receives a selection from the non-verbal person of a message that the non-verbal person desires to communicate to another person. The selection is received at portable device 30 through input device 40. PCA 42 translates a message selected by the non-verbal person into another format, such as text or audible, and communicates the message to another person through output device 38. PCA 42 may also receive a selection of a response message for translation and communication to the non-verbal person. PCA 42 may operate with conventional operating systems and multiple platforms of various hardware devices, such as PDAs, laptop and desktop computers and mobile telephones. This flexibility may reduce a need for customized communications devices, saving expense and resources.

Database 34 acts as a storage vehicle for portable device 30. In particular embodiments, database 34 includes messages which may be communicated from a non-verbal person to another person as described herein. The messages may be stored at database 34 in various formats. For example, the messages may be stored for selection in particular formats (for example, sign language, picture and/or symbol formats) and for communication in other formats (for example, audible or text formats). Messages may also be stored in parts. For example, as described above with respect to FIG. 1, some messages may be selected by selecting a high-level command and an item or task. Thus the storing of messages at database 34 may encompass storing particular high-level commands, items and tasks in various formats for selection and communication.

Components of portable device 30 may be implemented using any suitable combination of software, firmware, hardware or other suitable components. Software components of portable device 30 may be implemented according to any suitable software methodologies.

FIG. 4 illustrates a method for communication using a portable device. The method begins at step 100 where a plurality of messages is provided to a first person in a first format. The messages are provided at the portable device. The messages are messages which may be communicated to another person. The first person may be one who has difficulty effectively communicating verbally with others, such as an autistic or deaf person. The plurality of messages may be provided to the first person through menus or categories. The messages may be provided at an output device of the portable device, such as a display screen. The messages are provided in a first format that the first person can understand, such as sign language, pictures or symbols.

At step 102, a first selection is received from the first person. The first selection includes a selected message of the plurality of messages provided in step 100 that the first person desires to communicate to a second person. The second person may not be able to understand messages communicated in the first format. The first person may select the first message through an input device of the portable device, such as a keyboard, keypad, mouse, trackwheel or touch pad.

At step 104, the first message is translated to a second format. The second format may comprise a text format, an audible format or other type of format that the second person is able to understand. At step 106, the first message is communicated to the second person in the second format using the portable device. In particular embodiments, the message may be communicated through display on a screen of the portable device or through an audio output of a recorded human voice. In such cases, the recorded human voice may be the voice of one with whom the first person is familiar, such as a parent of the first person. Particular embodiments of the present invention may end at step 106.

Some embodiments may continue to step 108, where a second selection is received from the second person at the portable device. The second selection comprises a second message from the plurality of messages. The second message may be a response to the first message communicated to the second person in step 106. The second selection may be received at the portable device through a keyboard, keypad, mouse, trackwheel, touch pad or other input device. The second message may be selected while displayed to the second person in a format that the second person can understand, such as a text format. Such format may be different from the first format.

At step 110, the second message is translated to the first format. In particular embodiments, the second message may not be translated to the first format, but may be translated to another format which the first person understands. At step 112, the second message is communicated to the first person. Such communication may occur in the first format, or otherwise in the format to which the second message was translated.

Although the present invention has been described in detail, various changes and modifications may be suggested to one skilled in the art. It is intended that the present invention encompass such changes and modifications as falling within the scope of the appended claims.

What is claimed is:

1. A method for communicating using a portable device, comprising:
providing to a first person a plurality of messages for communication to another person, the plurality of messages provided in a first format at a portable device;
receiving from the first person a first selection at the portable device, the first selection comprising a first message that the first person desires to communicate to the second person, wherein the first message is selected from the plurality of messages;
translating the first message from the first format to a second format; and
communicating the first message to the second person in the second format using the portable device.

2. The method of claim 1, wherein the first format comprises sign language.

3. The method of claim 1, wherein the first format comprises a picture format.

4. The method of claim 1, wherein the second format comprises an audible format.

5. The method of claim 4, wherein the audible format comprises a recorded human voice.

6. The method of claim 1, further comprising:
receiving from the second person a second selection at the portable device, the second selection comprising a second message that the second person desires to communicate to the first person, wherein the second message is selected from the plurality of messages;
translating the second message to the first format; and
communicating the second message to the first person in the first format.

7. The method of claim 6, wherein the first format comprises sign language

8. The method of claim 1, further comprising:
receiving the plurality of messages at a stationary device;
storing the plurality of messages at the stationary device;
transmitting the plurality of messages from the stationary device to the portable device;
receiving the plurality of messages at the portable device;
storing the plurality of messages at the portable device.

9. The method of claim 8, wherein the stationary device comprises a personal computer.

10. The method of claim 1, wherein the portable device comprises a personal digital assistant (PDA).

11. The method of claim 1, wherein the first person comprises an autistic person.

12. The method of claim 1, wherein the first person comprises a deaf person.

13. The method of claim 1, wherein the first person comprises a non-verbal person.

14. The method of claim 1, wherein the first person communicates using a different language than the second person.

15. A system for communication comprising a portable device, the portable device comprising:
a database comprising a plurality of messages for communication;
a processor coupled to the database; and
a personal communications assistant executable by the processor, the personal communications assistant operable to:
provide the plurality of messages to a first person in a first format through an output device coupled to the processor;
receive from the first person a first selection comprising a first message that the first person desires to communicate to a second person, the first selection received through an input device coupled to the processor, wherein the first message is selected from the plurality of messages;
translate the first message from the first format to a second format; and
communicate the first message to the second person in the second format through the output device.

16. The system of claim 15, wherein the first format comprises sign language.

17. The system of claim 15, wherein the first format comprises a picture format.

18. The system of claim 15, wherein the second format comprises an audible format.

19. The system of claim 18, wherein the audible format comprises a recorded human voice.

20. The system of claim 15, wherein the personal communications assistant is further operable to:
receive from the second person a second selection, the second selection comprising a second message that the second person desires to communicate to the first person, wherein the second message is selected from the plurality of messages and is received through the input device; and
communicate the second selection to the first person in the first format through the output device.

21. The system of claim 20, wherein the first format comprises sign language

22. The system of claim 15, further comprising a stationary device coupled to the portable device, the stationary device operable to:
receive the plurality of messages;
store the plurality of messages; and
transmit the plurality of messages to the portable device.

23. The system of claim 22, wherein the stationary device comprises a personal computer.

24. The system of claim 15, wherein the portable device comprises a personal digital assistant (PDA).
